(19) United States
(12) Patent Application Publication
(10) Pub. No.: US 2025/0003398 A1
(43) Pub. Date: Jan. 2, 2025

(54) Harvesting Maximum Power from Industrial Vibrations Using Digital Twin Framework

(71) Applicant: International Business Machines Corporation, Armonk, NY (US)

(72) Inventors: Sarbajit K. Rakshit, Kolkata (IN); Manikandan Padmanaban, Chennai (IN); Jagabondhu Hazra, Bangalore (IN)

(21) Appl. No.: 18/214,652

(22) Filed: Jun. 27, 2023

(51) Int. Cl. F03G 7/08

(52) U.S. Cl. CPC F03G 7/08

(57) ABSTRACT

Piezoelectric transducer-based techniques for harvesting maximum power using a digital twin framework are provided. In one aspect, a system for power harvesting includes: a mechanical energy source; piezoelectric transducers disposed on the mechanical energy source; a digital twin module configured to generate a virtual model of the mechanical energy source; an optimizer configured to use the virtual model to forecast a vibrational frequency of different portions of the mechanical energy source, as well as potential vibration hotspots; and a controller configured to modulate the resonance frequency of the piezoelectric transducers present at the potential vibration hotspots based on the vibrational frequency forecast at the potential vibration hotspots such that the piezoelectric transducers harvest maximum power from the mechanical energy source. A near optimal resonance frequency that provides a net energy gain can be calculated by the optimizer. A method for power harvesting using the present system is also provided.

### BACKGROUND

The present disclosure relates to electromechanical energy harvesting, and more particularly, to piezoelectric transducer-based power generation techniques.

Piezoelectric transducers convert mechanical strain into electric power based on the piezoelectric effect, whereby certain materials produce an electric charge when subject to a mechanical stress. In this manner, piezoelectric transducers can be used to harvest useful electric power from ambient sources of mechanical energy such as mechanical vibrations generated by structures, vehicles, machinery, etc. As such, there is a large potential to harvesting this vibrational energy.

In practice, however, the vibrations generated by these mechanical energy sources typically do not remain uniform throughout operation. Thus, optimal energy harvesting cannot be achieved by simply applying piezoelectric transducers to these environments.

Therefore, techniques for maximizing the power harvested from mechanical energy sources such as industrial machinery by piezoelectric transducers would be desirable.

### SUMMARY

The present disclosure provides piezoelectric transducer-based techniques for harvesting maximum power from mechanical vibrations generated by industrial machinery using a digital twin framework to identify vibration hotspots and modulating the resonant frequency of the piezoelectric transducer to match a natural frequency of the mechanical vibrations. In one aspect of the present disclosure, a system for power harvesting is provided. The system includes: a mechanical energy source; piezoelectric transducers disposed on the mechanical energy source for harvesting electric power from the mechanical energy source; a digital twin module configured to generate a virtual model of the mechanical energy source; an optimizer configured to use the virtual model to forecast a vibrational frequency of different portions of the mechanical energy source, as well as potential vibration hotspots where a difference between the vibrational frequency and a resonance frequency of the piezoelectric transducers is less than a predetermined threshold; and a controller configured to modulate the resonance frequency of the piezoelectric transducers present at the potential vibration hotspots based on the vibrational frequency forecast at the potential vibration hotspots such that the piezoelectric transducers harvest maximum power from the mechanical energy source.

In another aspect of the present disclosure, another system for power harvesting is provided. The system includes: a mechanical energy source; piezoelectric transducers disposed on the mechanical energy source for harvesting electric power from the mechanical energy source; a digital twin module configured to generate a virtual model of the mechanical energy source; an optimizer configured to use the virtual model to forecast a vibrational frequency of different portions of the mechanical energy source, forecast potential vibration hotspots where a difference between the vibrational frequency and a resonance frequency of the piezoelectric transducers is less than a predetermined threshold, and calculate a near optimal resonance frequency of the piezoelectric transducers that provides a net energy gain; and a controller configured to modulate the resonance frequency of the piezoelectric transducers present at the potential vibration hotspots to the near optimal resonance frequency such that the piezoelectric transducers harvest maximum power from the mechanical energy source.

In yet another aspect of the present disclosure, a method for power harvesting is provided. The method includes: generating a virtual model of a mechanical energy source, the mechanical energy source having piezoelectric transducers disposed thereon for harvesting electric power from the mechanical energy source; using the virtual model to forecast a vibrational frequency of different portions of the mechanical energy source; forecasting potential vibration hotspots where a difference between the vibrational frequency and a resonance frequency of the piezoelectric transducers is less than a predetermined threshold; and modulating the resonance frequency of the piezoelectric transducers present at the potential vibration hotspots based on the vibrational frequency at the potential vibration hotspots such that the piezoelectric transducers harvest maximum power from the mechanical energy source.

A more complete understanding of the present disclosure, as well as further features and advantages of the present disclosure, will be obtained by reference to the following detailed description and drawings.

### BRIEF DESCRIPTION OF THE DRAWINGS

FIG. 1 is a diagram illustrating an exemplary computing environment according to an embodiment of the present disclosure;

FIG. 2 is a diagram illustrating an exemplary power harvesting system according to an embodiment of the present disclosure;

FIG. 3 is a diagram illustrating an exemplary neural network according to an embodiment of the present disclosure;

FIG. 4 is a plot illustrating piezoelectric power generation for a piezoelectric material according to an embodiment of the present disclosure; and

FIG. 5 is a diagram illustrating an exemplary methodology for power harvesting according to an embodiment of the present disclosure.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing.

Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

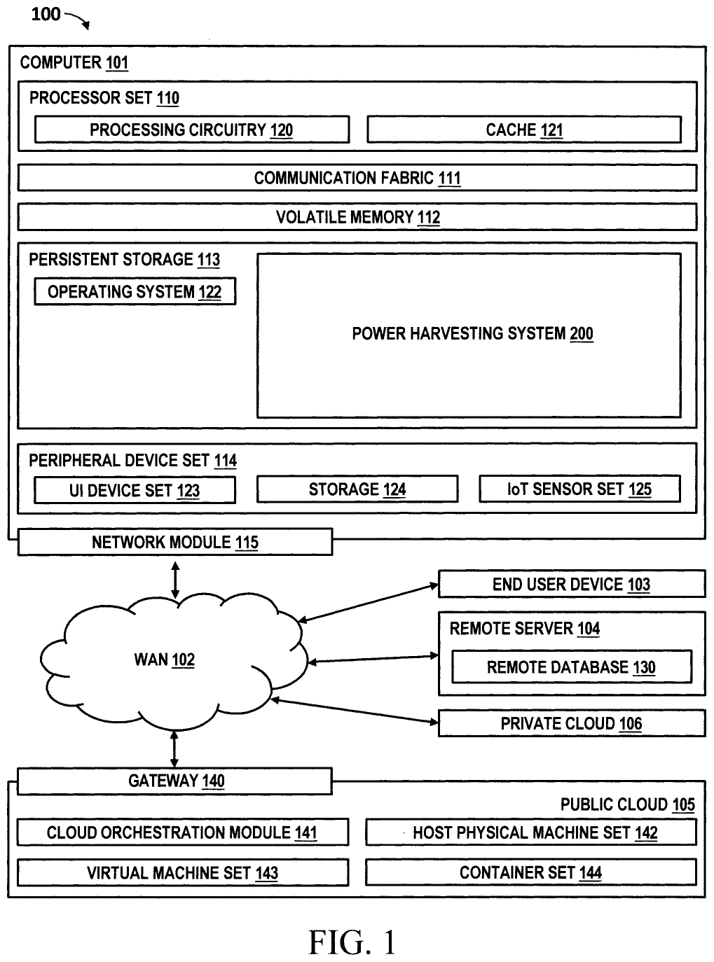

Referring to FIG. 1, computing environment 100 contains an example of an environment for the execution of at least some of the computer code involved in performing the disclosed methods, such as power harvesting system 200. In addition to system 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and system 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in system 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in system 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Piezoelectric transducers can advantageously be leveraged to harvest electric power from ambient sources of mechanical energy. For instance, industrial machinery can generate significant mechanical vibrations during operation which can be converted into useful electric power via piezoelectric transducer-based energy harvesters. However, the mechanical vibrations generated by industrial machinery typically are not uniform throughout an operation. Namely, as the load on different parts of the machinery changes, so does the frequency of the vibrations. Thus, for example, when one part of the machinery is called into play to process a product, the vibrational energy it generates under a high load may be different from when the product is then passed onto a next part of the machinery. Thus, the vibrations from such an energy source can change dynamically during operation.

Piezoelectric transducers employ piezoelectric materials that, via the piezoelectric effect, generate an electric charge when subject to a mechanical stress such as the stress produced by mechanical vibrations. A piezoelectric transducer generates maximum energy when it operates at the resonance frequency of the particular piezoelectric material used in the transducer, which is based on the stiffness constant of the piezoelectric material. In simple terms, the resonance frequency (f_{resonance}) is the oscillation of that piezoelectric material at its natural resonance. Thus, given that vibrations from a mechanical energy source such industrial machinery are non-uniform during operation, it is a notable challenge to employ piezoelectric transducers in a manner that, at any given point in time, are able to harvest maximum power since the frequency of the vibrations from the machinery is constantly changing, and oftentimes departs significantly from the resonance frequency of the piezoelectric material.

Advantageously, the present techniques leverage i) digital twin simulations to identify potential vibration hotspots in the mechanical energy source, and ii) the ability to dynamically modulate the piezoelectric transducer to operate closer to the frequency of the vibrations from the machinery at any point in time. Namely, a digital twin is a digital representation of a physical object or system and everything in it. A digital twin may be thought of as a virtual model that is designed to accurately reflect a physical object or objects. Namely, the object being studied such as an industrial machine is outfitted with various sensors related to the functioning of the machine. By way of example only, in accordance with the present techniques, an industrial machine can be outfitted with vibration sensors in order to identify potential vibration hotspots. The data captured via the sensors is processed and applied to the virtual model. Once this data is implemented in the virtual model, the virtual model can be used to run simulations for making various determinations, such as identifying potential vibration hotspots in the machinery, which can then be applied back to the physical object such as through modulation of the piezoelectric transducer to operate at or near the frequency of the vibrations at these identified hotspots. It is notable that reference herein to ‘potential’ vibration hotspots refers to the fact that the estimates of these vibrational hotspots come from the digital twin simulations, and are being forecast for various timesteps N.

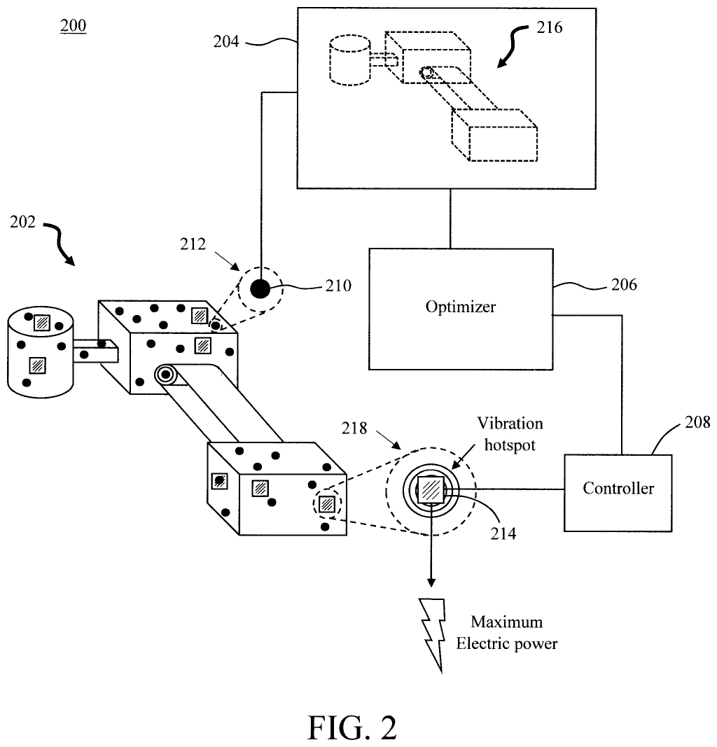

Specifically, referring to FIG. 2, an exemplary configuration of system 200 is provided. As shown in FIG. 2, system 200 includes a mechanical energy source 202, a digital twin module 204, an optimizer 206, and a controller 208. According to the exemplary embodiment shown in FIG. 2, the mechanical energy source 202 is an industrial machine which produces vibrations during operation. However, it is to be understood that the present techniques are more generally applicable to any source of mechanical energy such as structures like buildings which produce vibrations due to movement or operations within the building, vehicles which produce vibrations while in use, etc.

As shown in FIG. 2, mechanical energy source 202 has a plurality of sensors 210 associated therewith. As will be described in detail below, digital twin module 204 will leverage data from the sensors 210 to generate a virtual model 216 of the mechanical energy source 202. By way of example only, suitable sensors 210 include, but are not limited to, pressure sensors, temperature sensors and/or vibration sensors. According to an exemplary embodiment, at least a subset of the sensors 210 are vibration sensors, which will enable the forecasting of potential vibration hotspots of the mechanical energy source 202, as well as the vibrational frequency at these vibration hotspots. A magnified view of one of the sensors 210 is shown in inset 212 in order illustrate how system 200 feeds data from the sensors 210 to digital twin module 204 for generating the virtual model 216 of the mechanical energy source 202.

As also shown in FIG. 2, a plurality of piezoelectric transducers 214 are disposed on mechanical energy source 202 at different locations. According to an exemplary embodiment, each of the piezoelectric transducers 214 is a tile containing at least one piezoelectric material. Suitable piezoelectric materials include, but are not limited to, crystalline piezoelectric materials such as quartz, ceramic piezoelectric materials such as lead zirconate titanate (PZT), barium titanate, lead titanate, gallium nitride and/or zinc oxide, and/or polymeric piezoelectric materials such as polyvinylidene fluoride (PVDF). However, in general, any material exhibiting a piezoelectric effect (i.e., the ability to produce an electric charge when subject to a mechanical stress) can be used in accordance with the present techniques. Thus, the present teachings should not be construed as being limited to any piezoelectric material in particular, including those provided above. Each tile can contain a single layer or multiple layers of the piezoelectric material.

The digital twin module 204 generates a virtual model 216 (i.e., a digital representation) of the mechanical energy source 202. According to an exemplary embodiment, the digital twin module 204 leverages data from the sensors 210, along with physical characteristics of the mechanical energy source 202, to create this virtual model 216. By way of example only, the physical characteristics ingested by the digital twin module 204 can include, but are not limited to, floor plan data, work schedule data such as load, time, etc., and/or machinery characteristics such as load versus vibration.

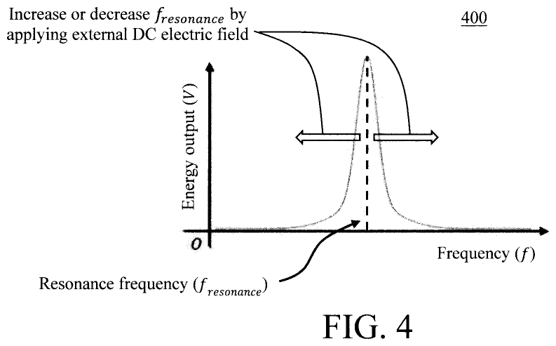

The virtual model 216 generated by digital twin module 204 is provided to the optimizer 206 for making determinations about energy harvesting which can then be applied back to the mechanical energy source 202. For instance, according to an exemplary embodiment, the optimizer 206 uses the virtual model 216 to forecast i) a vibrational frequency of different portions of the mechanical energy source 202, and ii) potential vibration hotspots (labeled “Vibration hotspot”) amongst those portions at various timesteps N. Namely, as described in detail above, the vibrations of mechanical energy source 202 are typically non-uniform during operation, meaning that the vibrations at different locations can vary over time depending, e.g., on changes in load. As will be described in detail below, predicting the potential vibration hotspots can involve estimating the gap (i.e., difference) between the vibrational frequency of the mechanical energy source 202 and the resonance frequency (f_{resonance}) of the piezoelectric transducers 214. In that case, data relating to the piezoelectric material of the piezoelectric transducers 214 is also needed, such as a characteristics profile of the piezoelectric material (e.g., its resonance frequency and electro-mechanical coupling), power constraints for step change, and/or stress and strain constraints of the piezoelectric material (beyond which behavior of the piezoelectric material is no longer linear). Regarding power constraints for step change, the power constraints are the power limits placed on the controller 208 for each timestep N (i.e., step change). As will be described in detail below, the power constraints of controller 208 will be considered while determining the near optimal resonance frequency of the piezoelectric transducers 214. According to an exemplary embodiment, potential vibration hotspots are those portions of the mechanical energy source 202 where the gap (i.e., difference) between the vibrational frequency at that portion and the resonance frequency (f_{resonance}) of the piezoelectric transducers 214 is less than a predetermined threshold. According to an exemplary embodiment, this predetermined threshold (gap) is a user-configurable parameter which is based, for example, on a rating of controller 208. For example, if the controller 208 can modulate the resonance frequency of the piezoelectric transducers 214 by ±10% from the natural/unaltered frequency (see, e.g., FIG. 4—described below), then the predetermined threshold (gap) should be within this ±10% frequency range.

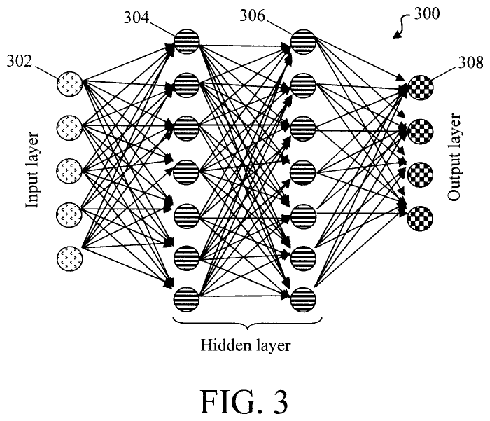

According to an exemplary embodiment, the optimizer 206 employs a machine learning model to make these predictions. In one embodiment, the machine learning model is a shallow or deep learning based neural network model. For instance, referring briefly to FIG. 3, an exemplary neural network 300 is provided. As shown in FIG. 3, a neural network such as neural network 300 generally includes a plurality of interconnected processor elements 302, 304/306 and 308 that form an input layer, at least one hidden layer, and an output layer, respectively, of the neural network 300. The connections in neural networks that carry electronic messages between simulated neurons are provided with numeric weights that correspond to the strength or weakness of a given connection. These numeric weights can be adjusted and tuned based on experience, making neural networks adaptive to inputs and capable of learning. Typically, neural networks are trained on labeled sets of training data. Once trained, the neural network can be used for inference. Inference applies knowledge from a trained neural network model and uses it to infer a result. A fully connected layer (typically the last or last few layers in a neural network) is a layer where all of the inputs from one layer are connected to every activation unit of the next layer. The fully connected layer(s) compile the data extracted by previous layers of the neural network to form the final output.

As also highlighted above, the resonance frequency of a piezoelectric material is the oscillation of that material at its natural resonance. It is at this resonance frequency (f_{resonance}) that a piezoelectric material produces its highest (i.e., maximum) electrical power output. See FIG. 4. Namely, FIG. 4 is a plot 400 illustrating piezoelectric power generation for a piezoelectric material. As shown in FIG. 4, energy output from the piezoelectric material peaks when the frequency (f) of the vibrations is at f_{resonance}. The energy output drops when f is less than or greater than f_{resonance}. Thus, in order to harvest maximum power by system 200, it is necessary to match the f_{resonance} of the piezoelectric transducers 214 as close as possible (i.e., at or near) the hotspot vibrational frequency. Otherwise, a less than optimal energy harvesting situation exists. In the example depicted in FIG. 4, the dashed line represents the natural (i.e., unaltered by any external electric field) resonance frequency of the piezoelectric material.

Advantageously, by applying an external direct current (DC) electric field to the piezoelectric material of the piezoelectric transducers 214, the elastic constant (which also may be referred to herein as the ‘stiffness constant’) of the piezoelectric material can be changed, thus changing (i.e., modulating) the resonance frequency (f_{resonance}) of the piezoelectric transducers 214. More to this point, the resonance frequency (f_{resonance}) of the piezoelectric transducers 214 can be increased or decreased as needed by simply changing the polarity of the DC electric field. See FIG. 4. For instance, applying a positive DC electric field to the piezoelectric material increases the f_{resonance} of the piezoelectric transducers 214, whereas applying a negative DC electric field to the piezoelectric material decreases the f_{resonance} of the piezoelectric transducers 214.

Thus, referring back to FIG. 2, in order to harvest maximum power from these non-uniform, potential vibration hotspots, the controller 208 is used to modulate the resonance frequency of the piezoelectric transducers 214 at the potential vibration hotspots to be closer to the vibrational frequency at those hotspots (as predicted by the optimizer 206 using the virtual model 216), thereby enabling those piezoelectric transducers 214 to harvest more power as compared to not modulating the resonance frequency. In other words, as highlighted above, the controller 208 serves to reduce the gap between the resonance frequency of the piezoelectric transducers 214 at the potential vibration hotspots and the vibrational frequency at those hotspots (considering overall power gain/lost and other constraints—see below). See, for example, the magnified view of one of the piezoelectric transducers 214 shown in inset 218 which is present at a location of one of the potential vibration hotspots. As will be described in detail below, embodiments are contemplated herein where the hotspot vibrational frequency predictions are made for a sequence of time steps N, and the controller 208 modulates the resonance frequency of the respective piezoelectric transducers 214 at each of those time steps N. By way of this process, the present system 200 corrects deviations of the hotspot vibrational frequency from the resonance frequency of the piezoelectric transducers 214.

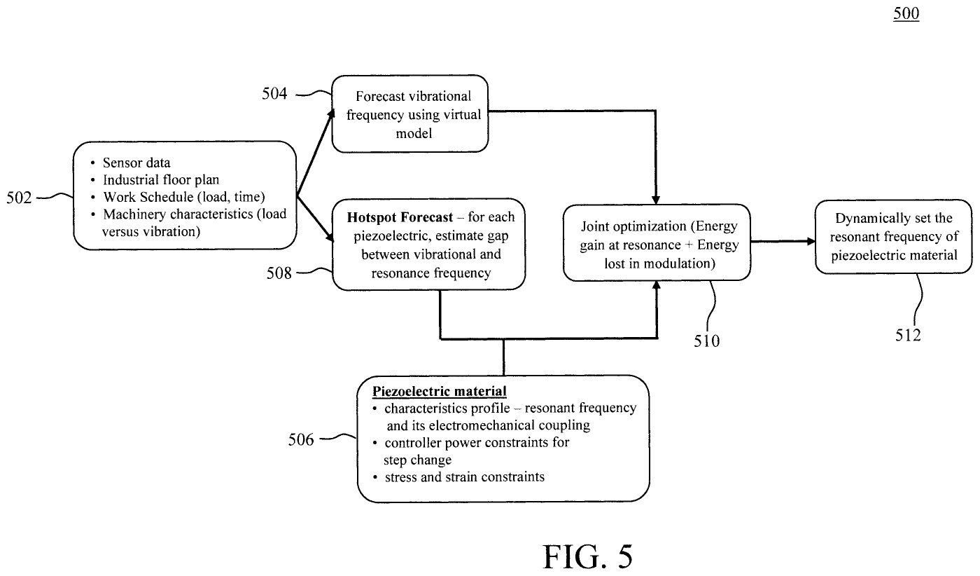

Further, optimizer 206 can also take into account the tradeoff between the additional energy gained and lost in changing the resonance frequency of the piezoelectric transducers 214, and choose a near optimal resonance frequency for modulation using a cost function to ensure net energy gain. This evaluation is referred to herein as joint optimization for net energy gain. An exemplary methodology 500 for power harvesting using system 200 that implements joint optimization for net energy gain is now described by way of reference to FIG. 5.

In step 502, input data is provided to the digital twin module 204 to generate a virtual model 216 (e.g., a digital representation) of the mechanical energy source 202. As highlighted above, this input data includes data from the sensors 210 (including, e.g., vibration sensor data), along with physical characteristics of the mechanical energy source 202. By way of example only, the physical characteristics data can include, but are not limited to, floor plan data, work schedule data such as load, time, etc., and/or machinery characteristics such as load versus vibration.

In step 504, the optimizer 206 uses the virtual model 216 to forecast a vibrational frequency of different portions of the mechanical energy source 202. The optimizer 206 also forecasts vibration hotspots. As highlighted above, predicting the vibration hotspots can involve estimating the gap (i.e., difference) between the vibrational frequency of the mechanical energy source 202 and the resonance frequency (f_{resonance}) of the piezoelectric transducers 214. As such, in step 506, data relating to the piezoelectric material of the piezoelectric transducers 214 is provided to optimizer 206. By way of example only, this piezoelectric data can include a characteristics profile of the piezoelectric material (e.g., its resonance frequency and electro-mechanical coupling), power constraints for step change (see above), and/or stress and strain constraints of the piezoelectric material (beyond which behavior of the piezoelectric material is no longer linear).

In step 508, the optimizer 206 forecasts potential vibration hotspots as those portions of the mechanical energy source 202 where the gap (i.e., difference) between the vibrational frequency at such portion and the resonance frequency (f_{resonance}) of the piezoelectric transducers 214 is less than a predetermined threshold. In step 510, the optimizer 206 uses a cost function (see below) to evaluate the additional energy gained and lost in changing the resonance frequency of the piezoelectric transducers 214 (i.e., to close the gap between the resonance frequency of the piezoelectric transducers 214 and the vibrational frequency at the vibration hotspots) in order to calculate a near optimal resonance frequency for modulation that provides a net energy gain. As shown in FIG. 5, and described in detail below, this evaluation also leverages the data relating to the piezoelectric material of the piezoelectric transducers 214 provided in the step 506.

In step 512, the controller 208 is used to modulate the resonance frequency of the piezoelectric transducers 214 present at the potential vibration hotspots based on the vibrational frequency at the vibration hotspots. More specifically, controller 208 (by applying an external DC electric field) changes the resonance frequency of the piezoelectric transducers 214 to the near optimal resonance frequency calculated in step 510.

As highlighted above, joint optimization for net energy gain is performed to choose a near optimal resonance frequency such that maximum energy can be harvested from the mechanical energy source 202 via the piezoelectric transducers 214 by operating at the resonance frequency of the piezoelectric material, and minimizing the energy lost in modulating/changing the resonance frequency of the piezoelectric material. For instance, in one embodiment, the following cost function/for total energy gain is employed:

$$J = Max \cdot {\sum }_{j = 1}^{N} \{ {w}_{G} \cdot {E}_{G} ( {f}_{j} , {f}_{c}^{*} ) - {w}_{L} \cdot {E}_{L} ( {f}_{j} , {f}_{c}^{*} ) - {\sum }_{i = 1}^{N} {{w}_{{uP}_{i}} ( {f}_{j} , {f}_{c}^{*} )}^{2} \} , \qquad ( 1 )$$

subject to:

$${f}_{j}^{min} \leq {f}_{j} \leq {f}_{j}^{max} , \qquad ( 2 )$$

where fⱼ is the predicted resonance frequency of wave energy for the forecasted time instant j, f*_{c} is the current operating resonance frequency of the piezoelectric material, E_{G} is the energy gain by operating the piezoelectric material at frequency fⱼ from the current operating frequency f*_{c}, E_{L} is the energy lost by modulating the piezoelectric material frequency to fⱼ from the current operating frequency f*_{c}, w_{G}, w_{L} are the weighing coefficients for an additional energy generated from the piezoelectric material and energy lost in changing the frequency to fⱼ from the current operating frequency f*_{c}, respectively, and fⱼ^{min}, fⱼ^{max} are the minimum and maximum limits for frequency respectively. The frequency fⱼ is what is referred to herein throughout as the near optimal resonance frequency of the piezoelectric transducers 214.

In Equation 1, the component w_{G}·E_{G}(fⱼ, f*_{c}) represents the additional energy that can be generated from the piezoelectric material by operating the predicted resonance frequency fⱼ at j instant close to the current operating frequency f*_{c}. Thus, if the piezoelectric material frequency is modulated to fⱼ from the current operating frequency fc then that is the energy gain. The component E_{L}(fⱼ, f*_{c}) represents the energy lost in modulating the resonance frequency of the piezoelectric material. The ‘energy lost’ refers to the external energy that system 200 needs to supply in the form of a DC electric field in order to modulate the resonance frequency of the piezoelectric material in piezoelectric transducers 214. The component Σᵢ₌₁^{N} w_{uP}_{ᵢ}(fⱼ, f*_{c})² imposes a penalty for large changes in frequency over N time steps to ensure that frequency is not being changed drastically from one time instance to the next, as doing so will result in high energy loss. Namely, the goal is to gradually increase or decrease frequency. For instance, consider a scenario where the system tries to change the resonance frequency of the piezoelectric transducers 214 drastically in time step ‘t’ (e.g., an increase by 10%) and immediately tries to reduce it by 15% in the next time step ‘t+1’. This will lead to high energy loss because of the energy required in modulating the resonance frequency in the short span of time. Thus, putting constraints on these bigger frequency changes will serve to reduce bigger changes in the frequency modulation within the considered time horizon, and thereby minimize the overall energy loss. Equation 2 imposes a constraint on the range of frequencies that the piezoelectric material can be adjusted to.

Although illustrative embodiments of the present disclosure have been described herein, it is to be understood that the present disclosure is not limited to those precise embodiments, and that various other changes and modifications may be made by one skilled in the art without departing from the scope of the present disclosure.

What is claimed is:

1. A system for power harvesting, the system comprising:
a mechanical energy source;
piezoelectric transducers disposed on the mechanical energy source for harvesting electric power from the mechanical energy source;
a digital twin module configured to generate a virtual model of the mechanical energy source;
an optimizer configured to use the virtual model to forecast a vibrational frequency of different portions of the mechanical energy source as well as potential vibration hotspots where a difference between the vibrational frequency and a resonance frequency of the piezoelectric transducers is less than a predetermined threshold; and
a controller configured to modulate the resonance frequency of the piezoelectric transducers present at the potential vibration hotspots based on the vibrational frequency forecast at the potential vibration hotspots such that the piezoelectric transducers harvest more power from the mechanical energy source as compared to not modulating the resonance frequency.

2. The system of claim 1, wherein the mechanical energy source comprises industrial machinery.

3. The system of claim 1, further comprising:
sensors associated with the mechanical energy source, wherein the digital twin module is configured to generate the virtual model using data from the sensors.

4. The system of claim 3, wherein the sensors comprise vibration sensors.

5. The system of claim 1, wherein the controller is configured to apply a direct current (DC) electric field to the piezoelectric transducers to modulate the resonance frequency of the piezoelectric transducers.

6. The system of claim 5, wherein the controller is configured to apply at least one of a positive DC electric field to increase the resonance frequency of one or more of the piezoelectric transducers, and a negative DC electric field to decrease the resonance frequency of another one or more of the piezoelectric transducers.

7. The system of claim 1, wherein the piezoelectric transducers comprise tiles disposed on the mechanical energy source which contain at least one piezoelectric material.

8. The system of claim 7, wherein the at least one piezoelectric material is selected from the group consisting of: quartz, lead zirconate titanate, barium titanate, lead titanate, gallium nitride, zinc oxide, polyvinylidene fluoride, and combinations thereof.

9. A system for power harvesting, the system comprising:
a mechanical energy source;
piezoelectric transducers disposed on the mechanical energy source for harvesting electric power from the mechanical energy source;
a digital twin module configured to generate a virtual model of the mechanical energy source;
an optimizer configured to use the virtual model to forecast a vibrational frequency of different portions of the mechanical energy source, forecast potential vibration hotspots where a difference between the vibrational frequency and a resonance frequency of the piezoelectric transducers is less than a predetermined threshold, and calculate a near optimal resonance frequency of the piezoelectric transducers that provides a net energy gain; and
a controller configured to modulate the resonance frequency of the piezoelectric transducers present at the potential vibration hotspots to the near optimal resonance frequency such that the piezoelectric transducers harvest more power from the mechanical energy source as compared to not modulating the resonance frequency.

10. The system of claim 9, wherein the near optimal resonance frequency of the piezoelectric transducers is calculated using a cost function that maximizes energy generation by operating at the resonance frequency of the piezoelectric transducers, and minimizes energy lost in modulating the resonance frequency of the piezoelectric transducers.

11. A method for power harvesting, the method comprising:
generating a virtual model of a mechanical energy source, the mechanical energy source having piezoelectric transducers disposed thereon for harvesting electric power from the mechanical energy source;
using the virtual model to forecast a vibrational frequency of different portions of the mechanical energy source;
forecasting potential vibration hotspots where a difference between the vibrational frequency and a resonance frequency of the piezoelectric transducers is less than a predetermined threshold; and
modulating the resonance frequency of the piezoelectric transducers present at the potential vibration hotspots based on the vibrational frequency at the potential vibration hotspots such that the piezoelectric transducers harvest more power from the mechanical energy source as compared to not modulating the resonance frequency.

12. The method of claim 11, wherein the mechanical energy source comprises industrial machinery.

13. The method of claim 11, further comprising:
generating the virtual model using data from sensors associated with the mechanical energy source.

14. The method of claim 13, wherein the sensors comprise vibration sensors.

15. The method of claim 11, further comprising:
applying a DC electric field to the piezoelectric transducers to modulate the resonance frequency of the piezoelectric transducers.

16. The method of claim 15, wherein the applying comprises:
applying at least one of a positive DC electric field to increase the resonance frequency of one or more of the piezoelectric transducers, and a negative DC electric field to decrease the resonance frequency of another one or more of the piezoelectric transducers.

17. The method of claim 11, wherein the piezoelectric transducers comprise tiles disposed on the mechanical energy source which contain at least one piezoelectric material.

18. The method of claim 17, wherein the at least one piezoelectric material is selected from the group consisting of: quartz, lead zirconate titanate, barium titanate, lead titanate, gallium nitride, zinc oxide, polyvinylidene fluoride, and combinations thereof.

19. The method of claim 11, further comprising:
calculating a near optimal resonance frequency of the piezoelectric transducers that provides a net energy gain; and
modulating the resonance frequency of the piezoelectric transducers present at the potential vibration hotspots to the near optimal resonance frequency.

20. The method of claim 19, wherein the near optimal resonance frequency of the piezoelectric transducers is calculated using a cost function that maximizes energy generation by operating at the resonance frequency of the piezoelectric transducers, and minimizes energy lost in modulating the resonance frequency of the piezoelectric transducers.
